(19) United States
(12) Patent Application Publication
(10) Pub. No.: US 2005/0238466 A1
(43) Pub. Date: Oct. 27, 2005

(54) Lifting dolly and methods of use thereof

(76) Inventor: Robert L. Henry, San Diego, CA (US)

Correspondence Address: DAVID R PRESTON & ASSOCIATES APC, 12625 HIGH BLUFF DRIVE, SUITE 205, SAN DIEGO, CA, 92130, US

(21) Appl. No.: 11/113,673

(22) Filed: Apr. 25, 2005

Related U.S. Application Data
(60) Provisional application No. 60/565,711, filed on Apr. 27, 2004.

(51) Int. Cl. B60P 3/00

(52) U.S. Cl. 414/444

(57) ABSTRACT

The present invention relates generally to the field of dollies and hand trucks, and particularly to a lifting dolly with a semicircular frame and methods of use thereof. The present invention is particularly adaptable as lifting dolly for moving live trees in root tubs in nurseries. Although primarily designed for moving trees with square or inverted-cone root tubs, the lifting dolly of the present invention is also adept at lifting and handling trees with roots contained in barrels or kegs. Sacks of nursery and construction material can also be easily lifted and transported with the lifting dolly of the present invention.

### RELATED DOCUMENTS

The present application claims benefit of priority from U.S. Provisional Patent Application Ser. No. 60/565,711, filed Apr. 27, 2004, entitled “Lifting Dolly and Methods of Use Thereof”, which is incorporated herein by reference in its entirety.

### FIELD OF INVENTION

The present invention relates generally to the field of dollies and hand trucks, and particularly to a lifting dolly with a semicircular frame and methods of use thereof.

### BACKGROUND OF THE INVENTION

A variety of hand trucks and dollies are commercially available. Hand trucks and dollies can be used for a variety of purposes, such as transportation of heavy plant pots, movement of heavy boxes in warehouses, movement of heavy furniture and equipment, and generally facilitating the movement of heavy articles from one point to another. Many of these hand trucks and dollies are awkward to maneuver and exert much strain on the operator's joints, back, and muscles. Many of the commercially available hand trucks and dollies can cause severe injuries when improperly handled or improperly balanced.

Each year in the united states, a great many workers in tree nurseries are injures while moving trees with roots in attached tubs, and in loading the trees onto delivery vehicles. The present invention provides a safer solution to the rising tide of back and other injuries incurred in the process of handling living trees in tree nurseries. In most cases, a single person can easily move trees from one place to another place in the nursery. While there has been a trend to produce safer and more maneuverable and efficient dollies and hand trucks, further improvements in the safety, effectiveness, and efficiency of dollies and hand trucks are desirable he present invention addresses these problems, and provides related benefits.

### SUMMARY OF THE INVENTION

The present invention relates generally to the field of dollies and hand trucks, and particularly to a lifting dolly with a semicircular frame and methods of use thereof. The present invention is particularly adaptable as lifting dolly for moving live trees in root tubs in nurseries. Although primarily designed for moving trees with square or inverted-cone root tubs, the lifting dolly of the present invention is also adept at lifting and handling trees with roots contained in barrels or kegs. Sacks of nursery and construction material can also be easily lifted and transported with the lifting dolly of the present invention. The present invention can be equipped with a demountable or clip-on panel that enables the dolly to be used as a landscapers tool or as a potting table when the dolly is not in use as a tree lifter or transporter. Additionally, the dolly can be fitted with a housing contained within the frame structure that can be used for storage of potting or other materials.

The present invention recognizes that most tree nurseries are cramped for room and all efforts are used to get maximum utility from every square foot of available space. Compact size of the present invention requires less maneuvering space compared with conventional fork-lifts, cranes, and other lifting devices and this results in more floor space available in the nursery for cultivation of additional trees. The lifting dolly is also very easy to load into the bed of a nursery delivery vehicle or the bed of a pick-up truck. The lifting dolly can be sent with the nursery delivery vehicle and assist the delivery person in off-loading trees and placement of trees exactly where the customer desires.

A first aspect of the present invention includes a lifting dolly including: a frame having: a right and a left substantially straight and substantially parallel support members, the right and the left support members being fixedly attached to one another by way of one or more cross members; and a right and a left substantially semi-circular and substantially parallel side members, the right and the left side members being fixedly attached to one another by way of one or more cross members, the right substantially semi-circular side member being fixedly attached at each end to each end of the right support member, and the left substantially semi-circular side member being fixedly attached at each end to each end of the left support member; a nose plate fixedly attached at substantially the point of junction of the support members with the substantially semi-circular side members, wherein the nose plate protrudes outward and away from the semi-circular side members; one or more stand-on-end wheels axially attached to the semi-circular side members at a distance away from the nose plate, the one or more stand-on-end wheels being capable of balancing the frame in substantially upright position; and a plurality of main wheels axially attached to the semi-circular side members at a distance away from the stand-on-end wheels and further away from the nose plate, the main wheels being capable of balancing the frame in substantially horizontal position; wherein the lifting dolly can engage a load substantially vertically and carry the load away substantially upright by way of the stand-on-end wheels or carry the load away substantially horizontally by way of the main wheels.

A second aspect of the present invention includes a lifting dolly including: means for supporting a load comprising a substantially straight means for engaging the load and a substantially semi-circular means for supporting the load in substantially vertical and substantially horizontal positions; means for engaging the underside of the load; and means for moving the load, the means for moving the load being attached to the substantially semi-circular means, the means for moving said load being able to balance the means for supporting the load in a substantially upright position or a substantially horizontal position; wherein the lifting dolly can engage the load substantially vertically and carry the load away substantially upright or substantially horizontally by way of the means for moving the load.

A third aspect of the present invention includes a method for transporting a load including the steps of: a) providing a frame having a substantially straight means for engaging a load and a substantially semi-circular means for supporting the load in substantially vertical and substantially horizontal positions; b) engaging the underside of the load by way of a nose plate; c) providing one or more wheels attached to the substantially semi-circular means, the one or more wheels being able to balance the frame in a substantially upright position or a substantially horizontal position; and d) tilting the frame onto the one or more wheels and carrying away the load away substantially upright or substantially horizontal by way of the one or more wheels.

### BRIEF DESCRIPTION OF THE DRAWINGS

FIG. 1 shows a perspective view of a lifting dolly.

FIG. 2A shows a top view of a lifting dolly.

FIG. 2B shows a side view of a lifting dolly.

FIG. 3A shows the handle side an end view of a lifting dolly.

FIG. 3B shows the nose plant side an end view of a lifting dolly.

FIGS. 4A-4E show usage and operation of the lifting dolly.

### DETAILED DESCRIPTION OF THE INVENTION

### Introduction

The present invention recognizes that dollies and hand trucks can be made more safe, effective, and efficient using support frame that is semi-circular on one side having one or more wheels which allow the lifting dolly to operate in both an upright position and horizontal position.

As a non-limiting introduction to the breadth of the present invention, the present invention includes several general and useful aspects, including:

1) a lifting dolly including:
a frame having:
   a right and a left substantially straight and substantially parallel support members, the right and the left support members being fixedly attached to one another by way of one or more cross members; and
   a right and a left substantially semi-circular and substantially parallel side members, the right and the left side members being fixedly attached to one another by way of one or more cross members, the right substantially semi-circular side member being fixedly attached at each end to each end of the right support member, and the left substantially semi-circular side member being fixedly attached at each end to each end of the left support member;
a nose plate fixedly attached at substantially the point of junction of the support members with the substantially semi-circular side members, wherein the nose plate protrudes outward and away from the semi-circular side members; one or more stand-on-end wheels axially attached to the semi-circular side members at a distance away from the nose plate, the one or more stand-on-end wheels being capable of balancing the frame in substantially upright position; and
a plurality of main wheels axially attached to the semi-circular side members at a distance away from the stand-on-end wheels and further away from the nose plate, the main wheels being capable of balancing the frame in substantially horizontal position;
wherein the lifting dolly can engage a load substantially vertically and carry the load away substantially upright by way of the stand-on-end wheels or carry the load away substantially horizontally by way of the main wheels.

2) A lifting dolly including:
means for supporting a load comprising a substantially straight means for engaging the load and a substantially semi-circular means for supporting the load in substantially vertical and substantially horizontal positions;
means for engaging the underside of the load; and
means for moving the load, the means for moving the load being attached to the substantially semi-circular means, the means for moving said load being able to balance the means for supporting the load in a substantially upright position or a substantially horizontal position;
wherein the lifting dolly can engage the load substantially vertically and carry the load away substantially upright or substantially horizontally by way of the means for moving the load.

3) a method for transporting a load including the steps of:
a) providing a frame having a substantially straight means for engaging a load and a substantially semi-circular means for supporting the load in substantially vertical and substantially horizontal positions;
b) engaging the underside of the load by way of a nose plat;
c) providing one or more wheels attached to the substantially semi-circular means, the one or more wheels being able to balance the frame in a substantially upright position or a substantially horizontal position; and
d) tilting the frame onto the one or more wheels and carrying away the load away substantially upright or substantially horizontal by way of the one or more wheels.

The present invention relates generally to dollies and hand trucks, and particularly to a lifting dolly with a semicircular frame and methods of use thereof. The present invention is particularly adaptable as lifting dolly for moving live trees in root tubs in nurseries. Although primarily designed for moving trees with square or inverted-cone root tubs, the lifting dolly of the present invention is also adept at lifting and handling trees with roots contained in barrels or kegs. Sacks of nursery and construction material can also be easily lifted and transported with the lifting dolly of the present invention.

Further objectives and advantages of the present invention will become apparent as the description proceeds and when taken in conjunction with the accompanying drawings. To gain a full appreciation of the scope of the present invention, it will be further recognized that various aspects of the present invention can be combined to make desirable embodiments of the invention.

Unless defined otherwise, all technical and scientific terms used herein have the same meaning as commonly understood by one of ordinary skill in the art to which this invention belongs. Where a term is provided in the singular, the inventor also contemplates the plural of that term. The nomenclature used herein and the procedures described below are those well known and commonly employed in the art.

I. A Lifting Dolly

The present invention relates generally to dollies and hand trucks, and particularly to a lifting dolly with a semicircular frame and methods of use thereof.

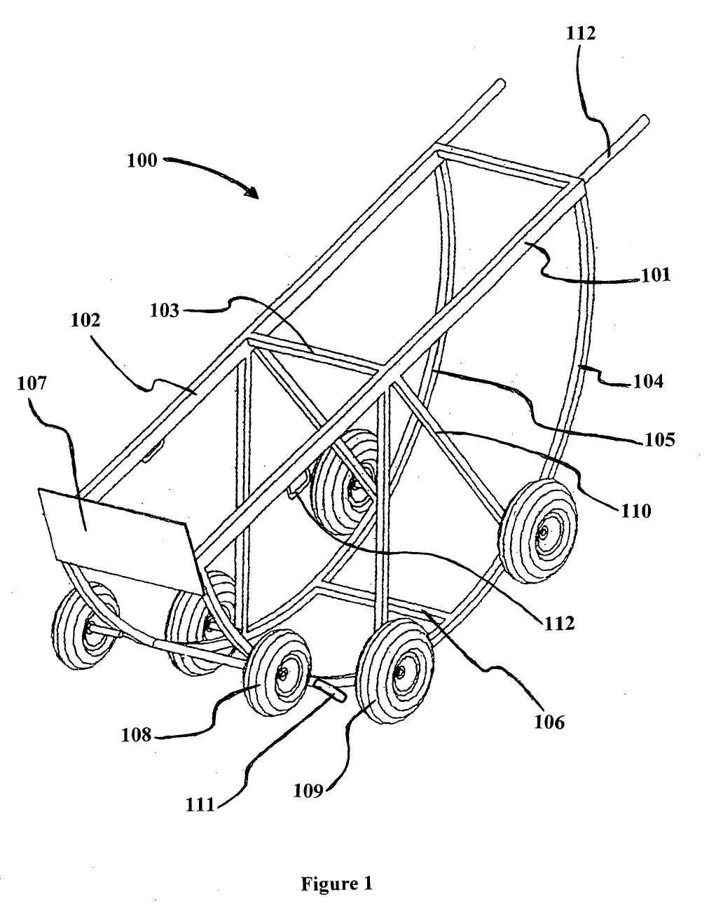

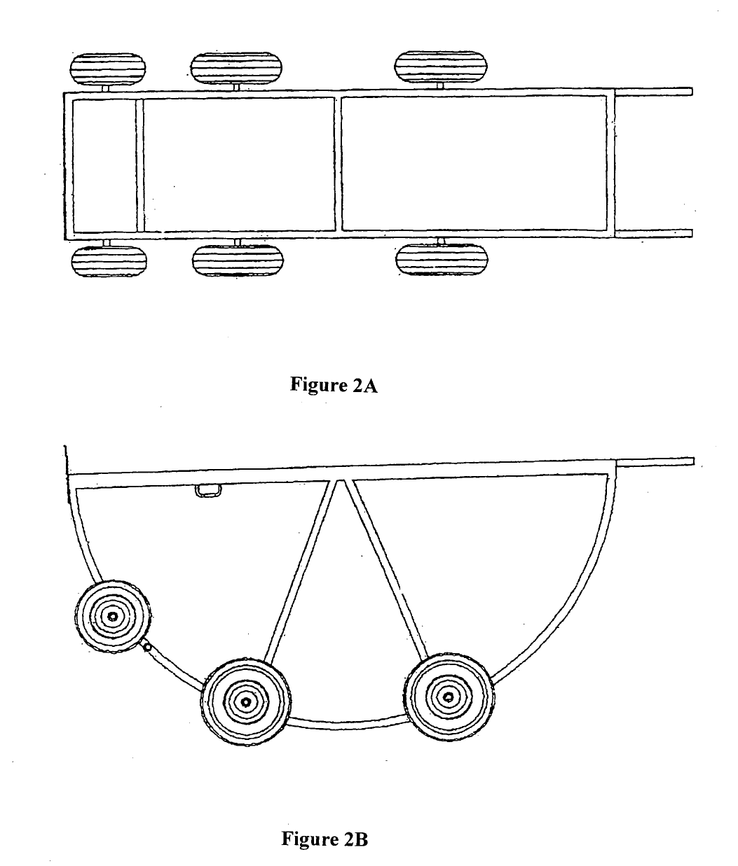

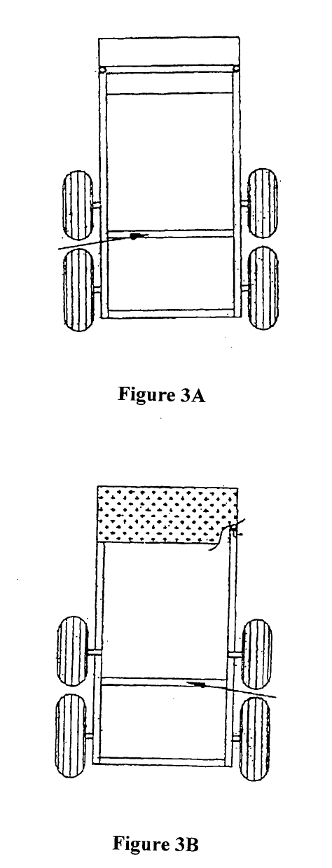

Referring to FIG. 1-4E, the lifting dolly 100 includes a frame having a right 101 and a left 102 substantially straight and substantially parallel support members, the right and the left support members being fixedly attached to one another by way of one or more cross members 103. The frame can be manufactured from any rigid material or combination thereof, preferably, metals such as aluminium, steel, stainless steel, etc. However, certain embodiments of the present invention may be manufactured from rigid plastics, rubber, woods, carbon composite material, or any variation or combination thereof. The right 101 and the left 102 substantially straight and substantially parallel support members can be separated by any suitable distance depending on the load that is to be carried. In some embodiments of the present invention the right 101 and the left 102 substantially straight and substantially parallel support members can be connected to each other so that to produce only one support member, or the right 101 and the left 102 substantially straight and substantially parallel support members can be made movable and adjustable by any proper means so that any desired distance of separation between the two can be achieved depending on the requirement of the load to be carried.

The present invention also includes a right 104 and a left 105 substantially semi-circular and substantially parallel side members, the right and the left side members being fixedly attached to one another by way of one or more cross members 106, the right substantially semi-circular side member 104 being fixedly attached at each end to each end of the right support member 101, and the left substantially semi-circular side member 105 being fixedly attached at each end to each end of the left support member 102. All fixed attachments of the present invention may be attached by any proper attaching means, such as for example, by weld, bolts, screws, rivets, or other proper attaching means. The right 104 and the left 105 and related connecting cross members 106 substantially semi-circular and substantially parallel side members manufactured from any rigid material or combination thereof, preferably, metals such as aluminium, steel, stainless steel, etc. However, certain embodiments of the present invention may be manufactured from rigid plastics, rubber, woods, carbon composite material, or any variation or combination thereof. The present invention may also include one or more radial cross members 110 fixedly attaching the substantially semi-circular and substantially parallel side members 104 and 105 to the substantially straight and substantially parallel support members 101 and 102. In some embodiments where the substantially straight and substantially parallel support members 101 and 102 are united to form only one support member or are made to be movable and adjustable, the substantially semi-circular and substantially parallel side members 104 and 105 and related one or more radial cross members 110 can be directly attached to the substantially straight and substantially parallel support members 101 and 102, or alternatively be indirectly attached to an intermediate connecting member.

The present invention also includes a nose plate 107 fixedly attached at substantially the point of junction of the support members 101 and 102 with the substantially semi-circular side members, wherein the nose plate 107 protrudes outward and away from the semi-circular side members 104 and 105. The nose plate can be manufactured from any rigid material or combination thereof, preferably, metals such as aluminium, steel, stainless steel, etc. However, certain embodiments of the present invention may be manufactured from rigid plastics, rubber, woods, carbon composite material, or any variation or combination thereof. During use of the present invention, the nose plate 107 can be brought close to the bottom side of a load to be carried, then the load to be carried can be tilted to expose the underside of the load to be carried, then the nose plate 107 of the lifting dolly 100 can be forced underneath the load to be carried and the load tilted back to level position to be carried away. Preferably, the lifting dolly 100 of the present invention includes a kick bar 111 attached on one or both of the semi-circular side members 104 and 105, the kick bar is preferably attached just behind the one or more stand-on-end wheels 108.

The present invention also includes one or more stand-on-end wheels 108 axially attached to the semi-circular side members 104 and 105 at a distance away from the nose plate 107, the one or more stand-on-end wheels 108 being capable of balancing the frame in substantially upright position. The stand-on-end wheels 108 are preferably provided in pairs axially attached to the semi-circular side members 104 and 105. The stand-on-end wheels 108 can be any type of suitable wheels, but preferably, the stand-on-end wheels 108 are rubber wheels and are positioned in pairs, each axially attached to the semi-circular side members 104 and 105, and more preferably the stand-on-end wheels 108 are axially attached outwardly so as not to interfere with any object that is being moved. The dimensions of the stand-on-end wheels 108 can be any suitable dimensions depending of the requirement of the load to be carried, preferably, the stand-on-end wheels 108 have a diameter of 10 inches.

The present invention also includes a plurality of main wheels 109 axially attached to the semi-circular side members 104 and 105 at a distance away from the stand-on-end wheels 108 and further away from the nose plate 107, the main wheels 109 being capable of balancing the frame in substantially horizontal position. The main wheels 109 are preferably provided in pairs axially attached to the semi-circular side members main wheels 109. The main wheels 109 can be any type of suitable wheels, but preferably, the main wheels 109 are rubber wheels and are positioned in pairs, each axially attached to the semi-circular side members 104 and 105, and more preferably the main wheels 109 are axially attached outwardly so as not to interfere with any object that is being moved. The dimensions of the main wheels 109 can be any suitable dimensions depending of the requirement of the load to be carried, preferably, the main wheels 109 have a diameter of 12 inches.

The lifting dolly 100 of the present invention can engage a load substantially vertically and carry the load away substantially upright by way of the stand-on-end wheels 108 or carry the load away substantially horizontally by way of the main wheels 109.

In a preferred embodiment, one or more handles 112 are provided. Preferably, two handles 112 are provided, one at each of the ends of the substantially straight and substantially parallel support members 101 and 102 that are farthest away from the nose plate 107. Also, one or more handles 112 can be provided on the lengths of substantially straight and substantially parallel support members 101 and 102 for facilitating the movement of the lifting dolly 100 in use.

In another preferred embodiment, a detachable panel covering across the substantially straight and substantially parallel support members are provide. The detachable panel should be capable of acting as a bench in providing a support surface for objects, such as potted plants, tools, or similar type material when the lifting dolly 100 is in a horizontal position.

### EXAMPLES

### I. Example I

### Use and Operation of the Lifting Dolly

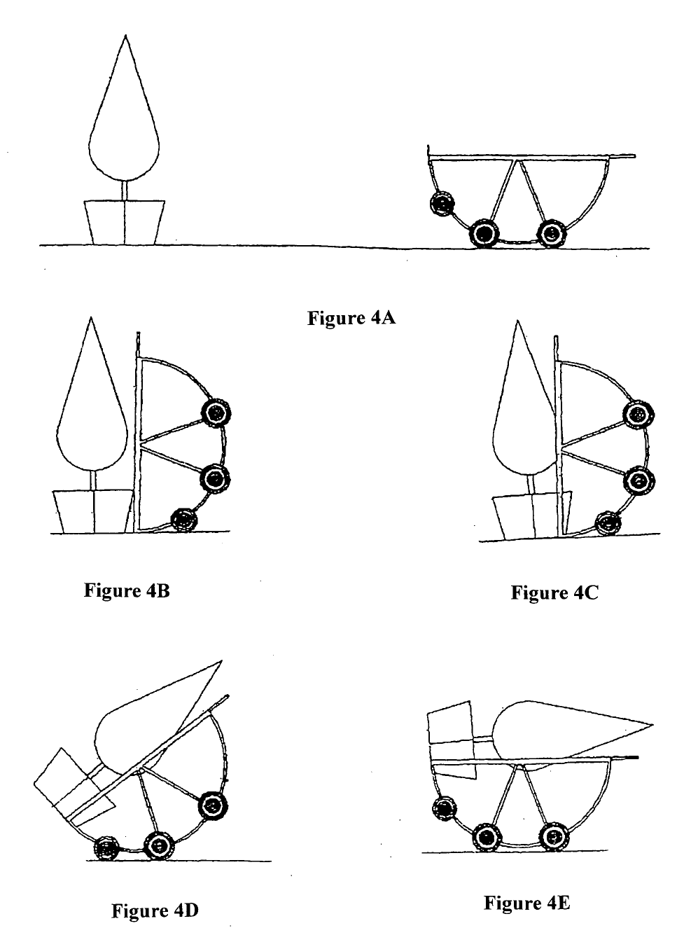

Referring to FIGS. 4A-4E, the lifting dolly is wheeled to the tree to be moved and the dolly is stood on end with the tip of the dolly's nose plate placed against a corner of the bottom edge of the tree root tub FIG. 4B. The corner of the root tub is raised slightly and the tip of the dolly nose plate is forced as far as possible under the corner of the root tub by kicking the kick bar FIG. 4C. The corner of the root but should be located equidistant between the straight support members of the dolly frame. Load restraint system is attached and the tree and root tub secured to the dolly. The handles of the dolly frame are pulled in downward direction and the tree and root tub are lifted until the dolly is balanced on the stand-on-end wheels and the first pair of the main wheels in an upright position FIG. 4D. The tree and root tub is then checked to make sure it is securely fastened to the dolly and the corners of the root tub is nestled between the straight support members of the dolly frame. The handles of the dolly are pulled further downward until the dolly is balanced on both sets of the main wheels in a horizontal position FIG. 4E. The dolly and the tree are then moved to another location and the root tub and tree offloaded.

All headings are for the convenience of the reader and should not be used to limit the meaning of the text that follows the heading, unless so specified. Various changes and departures may be made to the present invention without departing from the spirit and scope thereof. Accordingly, it is not intended that the invention be limited to that specifically described in the specification or as illustrated in the drawings, but only as set forth in the claims.

1. A lifting dolly comprising:
a frame comprising:
a right and a left substantially straight and substantially parallel support members, said right and said left support members being fixedly attached to one another by way of one or more cross members; and
a right and a left substantially semi-circular and substantially parallel side members, said right and said left side members being fixedly attached to one another by way of one or more cross members, said right substantially semi-circular side member being fixedly attached at each end to each end of said right support member, and said left substantially semi-circular side member being fixedly attached at each end to each end of said left support member;
a nose plate fixedly attached at substantially the point of junction of said support members with said substantially semi-circular side members, wherein said nose plate protrudes outward and away from said semi-circular side members;
one or more stand-on-end wheels axially attached to said semi-circular side members at a distance away from said nose plate, said one or more stand-on-end wheels being capable of balancing said frame in substantially upright position; and
a plurality of main wheels axially attached to said semi-circular side members at a distance away from said stand-on-end wheels and further away from said nose plate, said main wheels being capable of balancing said frame in substantially horizontal position;
wherein said lifting dolly can engage said load substantially vertically and carry said load away substantially upright by way of said stand-on-end wheels or carry said load away substantially horizontally by way of said main wheels.

2. The lifting dolly of claim 1, further comprising one or more radial cross members fixedly attaching said substantially semi-circular and substantially parallel side members to said substantially straight and substantially parallel support members.

3. The Lifting dolly of claim 1, further comprising one or more handles.

4. The lifting dolly of claim 1, further comprising one or more kick bars.

5. The lifting dolly of claim 1, further comprising a detachable panel covering across said substantially straight and substantially parallel support members, said detachable panel being capable of providing a support surface when said lifting dolly is in a horizontal position.

6. A lifting dolly comprising:
means for supporting a load comprising a substantially straight means for engaging said load and a substantially semi-circular means for supporting said load in substantially vertical and substantially horizontal positions;
means for engaging the underside of said load;
means for moving said load, said means for moving said load being attached to said substantially semi-circular means, said means for moving said load being able to balance said means for supporting said load in a substantially upright position or a substantially horizontal position;
wherein said lifting dolly can engage said load substantially vertically and carry said load away substantially upright or substantially horizontally by way of said means for moving said load.

7. The lifting dolly of claim 6, further comprising one or more radial cross members fixedly attaching said substantially straight means for engaging said load and said substantially semi-circular means for supporting said load.

8. The Lifting dolly of claim 6, further comprising one or more handles.

9. The lifting dolly of claim 6, further comprising one or more kick bars.

10. The lifting dolly of claim 6, further comprising a detachable panel covering across substantially straight means for engaging said load, said detachable panel being capable of providing a support surface when said lifting dolly is in a horizontal position.

11. A method for transporting a load comprising the steps of:
a) providing a frame comprising a substantially straight means for engaging a load and a substantially semi-circular means for supporting said load in substantially vertical and substantially horizontal positions;
b) engaging the underside of said load by way of a nose plate;
c) providing one or more wheels attached to said substantially semi-circular means, said one or more wheels being able to balance said frame in a substantially upright position or a substantially horizontal position; and
d) tilting said frame onto said one or more wheels and carrying away said load away substantially upright or substantially horizontal by way of said one or more wheels.

12. The method of claim 11, further comprising one or more radial cross members fixedly attaching said substantially semi-circular means to said substantially straight means.

13. The method of claim 12, wherein said frame further comprises one or more handles.

14. The method of claim 13, wherein said frame further comprises one or more kick bars.

15. The method of claim 14, wherein said frame further comprises a detachable panel covering across said substantially straight means, said detachable panel being capable of providing a support surface when said frame is in a horizontal position.
